(19) United States
(12) Patent Application Publication
(10) Pub. No.: US 2017/0135078 A1
(43) Pub. Date: May 11, 2017

(54) METHOD AND APPARATUS FOR CONFIGURING SUBFRAME IN MOBILE COMMUNICATION SYSTEM

(71) Applicant: ELECTRONICS AND TELECOMMUNICATIONS RESEARCH INSTITUTE, Daejeon (KR)

(72) Inventors: Kwang Jae LIM, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 15/348,376

(22) Filed: Nov. 10, 2016

(30) Foreign Application Priority Data
Nov. 10, 2015 (KR) 10-2015-0157720
Oct. 31, 2016 (KR) 10-2016-0143635

(51) Int. Cl. H04W 72/04

(52) U.S. Cl. CPC H04W 72/042; H04W 72/0413; H04W 72/0446

(57) ABSTRACT

Disclosed herein is a method for configuring a subframe by a transmitting apparatus in a mobile communication system, including: configuring the subframe consisting of a downlink control information transmission interval in which control information of a downlink is transmitted, a data transmission interval in which data are transmitted, an uplink control information transmission interval in which control information of an uplink is transmitted, and a response signal transmission interval in which a response signal to data reception is transmitted; and transmitting the subframe.

### CROSS-REFERENCE TO RELATED APPLICATION

This application claims priority to and the benefit of Korean Patent Application No. 10-2015-0157720 and 10-2016-0143635 filed in the Korean Intellectual Property Office on Nov. 10, 2015 and Oct. 31, 2016, the entire contents of which are incorporated herein by reference.

### BACKGROUND OF THE INVENTION

(a) Field of the Invention

The present invention relates to a method and an apparatus for configuring a subframe in a mobile communication system, and more particularly, to a method and an apparatus for configuring a subframe capable of increasing transmission efficiency in a mobile communication system.

(b) Description of the Related Art

In a configuration of a frame or a subframe of the existing mobile communication system, when a downlink transmission interval and an uplink transmission interval for downlink and uplink transmission are differentiated in advance by a frequency in the case of frequency division duplexing (FDD) and by a subframe in the case of time division duplexing (TDD) or are fixed depending on a system configuration. When the downlink transmission interval and the uplink transmission interval are fixed in advance, variable resource allocation is limited depending on a traffic condition, and therefore transmission efficiency may be reduced.

Further, in the case of a TDD system, a guard interval between the downlink transmission interval and the uplink transmission interval is fixed depending on the system configuration, and therefore a time corresponding to the guard interval may be wasted at all times.

### SUMMARY OF THE INVENTION

The present invention has been made in an effort to provide a method and an apparatus for configuring a subframe in a mobile communication system having advantages of increasing transmission efficiency.

An exemplary embodiment of the present invention provides a method for configuring a subframe by a transmitting apparatus in a mobile communication system. The method for configuring a subframe includes: configuring the subframe consisting of a downlink control information transmission interval in which control information of a downlink is transmitted, a data transmission interval in which data are transmitted, an uplink control information transmission interval in which control information of an uplink is transmitted, and a response signal transmission interval in which a response signal to data reception is transmitted; and transmitting the subframe.

In the subframe, guard intervals may be located between the downlink control information transmission interval and the data transmission interval and between the data transmission interval and the uplink control information transmission interval, respectively.

When the data transmission interval is used as a downlink data transmission, the guard interval between the downlink control information transmission interval and the data transmission interval may be used as a transmission interval of additional downlink data or downlink control information.

In the guard interval between the downlink control information transmission interval and the data transmission interval, a multi-carrier partial symbol having a time length smaller than or equal to the guard interval may be transmitted.

A length of the multi-carrier partial symbol may be determined by a largest integer n satisfying a relationship of L_{CP}+L/2ⁿ≦L_{GI} and a subcarrier spacing) of the multi-carrier partial symbol may have a relationship of 2ⁿΔf, and the L_{CP} may represent a length of CP, the n may represent 0 or a positive integer, the L_{GI} may represent a length of the guard interval, the L may represent a length of an effective symbol interval other than the CP in a symbol transmitted in the data transmission interval, and Δf may represent a subcarrier spacing of the symbol transmitted in the data transmission interval.

Some interval continued to the data transmission interval in the guard interval between the data transmission interval and the uplink control information transmission interval may be used to transmit additional downlink data or downlink control information.

In the some interval, a multi-carrier partial symbol may be transmitted, a length of the multi-carrier partial symbol may be determined by a largest integer n satisfying a relationship of L_{CP}+L/2ⁿ≦L_{GI}−L_{SW}−L_{RTD} and a subcarrier spacing of the multi-carrier partial symbol may have a relationship of 2ⁿΔf, and the L_{CP} may represent a length of CP, the n may represent 0 or a positive integer, the L_{GI} may represent a length of the guard interval, the L may represent a length of an effective symbol interval other than the CP in a symbol transmitted in the data transmission interval, the L_{SW} may represent a switching time between uplink transmissions after receiving a downlink, the L_{RTD} may represent a round-trip delay time estimated between the base station and the terminal, and Δf may represent a subcarrier spacing of the symbol transmitted in the data transmission interval.

When the data transmission interval is used as an uplink data transmission, a guard interval between the data transmission interval and the uplink control information transmission interval may be used as a transmission interval of additional uplink data or uplink control information.

In the guard interval between the data transmission interval and the uplink control information transmission interval, a multi-carrier partial symbol having a time length smaller than or equal to the guard interval may be transmitted.

A length of the multi-carrier partial symbol may be determined by a largest integer n satisfying a relationship of L_{CP}+L/2ⁿ≦L_{GI} and a subcarrier spacing of the multi-carrier partial symbol may have a relationship of 2ⁿΔf, and the L_{CP} may represent a length of CP, the n may represent 0 or a positive integer, the L_{GI} may represent a length of the guard interval, the L may represent a length of an effective symbol interval other than the CP in a symbol transmitted in the data transmission interval, and Δf may represent a subcarrier spacing of the symbol transmitted in the data transmission interval.

Another embodiment of the present invention provides an apparatus for configuring a subframe in a mobile communication system. The apparatus for configuring a subframe includes a processor and a transceiver. The processor may configure the subframe consisting of a downlink control information transmission interval in which control information of a downlink is transmitted, a data transmission interval in which data are transmitted, an uplink control information transmission interval in which control information of an uplink is transmitted, and a response signal transmission interval in which a response signal to data reception is transmitted. A transceiver may be connected to the processor to transmit the subframe. In the subframe, guard intervals may be located between the downlink control information transmission interval and the data transmission interval and between the data transmission interval and the uplink control information transmission interval, respectively.

When the data transmission interval is used as a downlink data transmission, the processor may use the guard interval between the downlink control information transmission interval and the data transmission interval as a transmission interval of additional downlink data or downlink control information.

The processor may generate a multi-carrier partial symbol to be transmitted in the guard interval between the data transmission interval and the uplink control information transmission interval and the multi-carrier partial symbol may have a time length smaller than or equal to the guard interval.

The processor may use some interval continued to the data transmission interval in the guard interval between the data transmission interval and the uplink control information transmission interval to transmit additional downlink data or downlink control information.

The processor may generate a multi-carrier partial symbol to be transmitted in the some interval.

When the data transmission interval is used as an uplink data transmission, the processor may use a guard interval between the data transmission interval and the uplink control information transmission interval as a transmission interval of additional uplink data or uplink control information.

The processor may generate a multi-carrier partial symbol to be transmitted in the guard interval between the data transmission interval and the uplink control information transmission interval and the multi-carrier partial symbol may have a time length smaller than or equal to the guard interval.

### BRIEF DESCRIPTION OF THE DRAWINGS

FIG. 1 is a diagram illustrating a configuration of a subframe according to an exemplary embodiment of the present invention.

FIG. 2 is a diagram illustrating an example of the configuration of the subframe when a data transmission interval of the subframe according to the exemplary embodiment of the present invention is used as a downlink data transmission.

FIG. 3 is a diagram illustrating an example of the configuration of the subframe when a data transmission interval of the subframe according to the exemplary embodiment of the present invention is used as an uplink data transmission.

FIG. 4 is a diagram illustrating an example of a configuration of a subframe when a data transmission interval of a subframe according to another exemplary embodiment of the present invention is used as a downlink data transmission.

FIG. 5 is a diagram illustrating a configuration of a multi-carrier partial symbol additionally transmitted in a guard interval according to an exemplary embodiment of the present invention.

FIG. 6 is a diagram illustrating an apparatus for configuring a subframe according to an exemplary embodiment of the present invention.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations DeletedTexts (a femto base station (femto BS), a home node B (HNB), a home eNodeB (HeNB), a pico base station (pico BS), a metro base station (metro BS), a micro base station (micro BS), and the like) DeletedTexts, and the like and may also include all or some of the functions of the ABS, the HR-BS, the node B, the eNodeB, the AP, the RAS, the BTS, the MMR-BS, the RS, the RN, the ARS, the HR-RS, the small base stations, and the like.

Hereinafter, a method and an apparatus for configuring a subframe in a mobile communication system according to an exemplary embodiment of the present invention will be described in detail with the accompanying drawings.

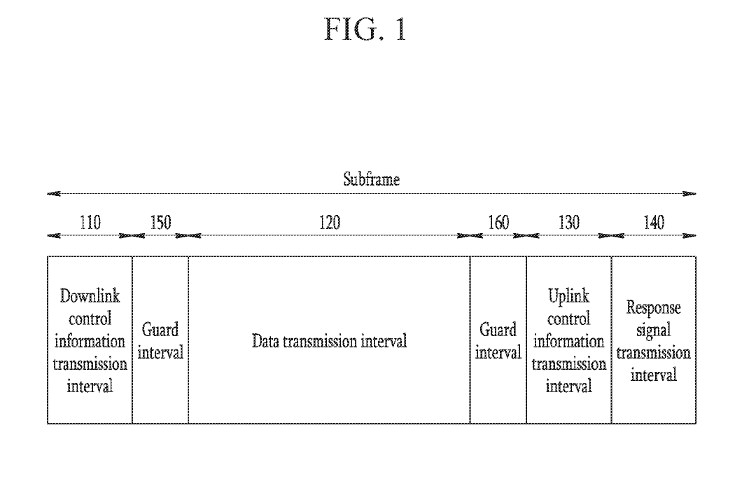

FIG. 1 is a diagram illustrating a configuration of a subframe according to an exemplary embodiment of the present invention.

Referring to FIG. 1, one subframe consists of a downlink control information transmission interval 110, a data transmission interval 120, an uplink control information transmission interval 130, and a response signal transmission interval 140, on a time base. Further, one subframe includes guard intervals 150 and 160 for switching between a downlink transmission and an uplink transmission between the downlink control information transmission interval and the data transmission interval and between the data transmission interval and the uplink control information transmission interval.

The guard intervals 150 and 160 are set to include a round-trip delay time up to a cell boundary and a switching time for uplink transmission after a terminal receives a downlink signal.

The downlink control information transmission interval 110 is a time interval for transmitting downlink control information from a base station to the terminal and includes allocation information indicating a data transmission in the subsequent data transmission interval 120

The data transmission interval 120 is used to transmit the downlink data or the uplink data depending on allocation information of the downlink control information transmission interval.

The uplink control information transmission interval 130 is a time interval for transmitting uplink control information from the terminal to the base station and may be used to transmit uplink channel status information (CSI) measured by the terminal or a sounding signal for uplink channel measurement by the base station. The response signal transmission interval 140 is a time interval for transmitting a hybrid automatic repeat and request (HARQ) response signal, and when the data transmission interval 120 in the current or previous subframe is used to transmit the downlink data, is used to transmit, by the terminal, an uplink response signal as a response to a downlink data reception and when the data transmission section 120 in the current or previous subframe is used to transmit the uplink data, is used to transmit, by the base station, the downlink response signal as a response to an uplink data reception. When the response signal transmission interval 140 is used by the base station or the terminal, the uplink control information transmission interval 130 is used by the terminal, the uplink control information transmission interval 130 and the response signal transmission interval 140 both are used by the terminal, the terminals using the uplink control information transmission interval 130 and the response signal transmission interval 140 may be the same terminal or different terminals.

To receive the data of the data transmission interval 120 and then transmit the response signal in the same subframe, it takes time to demodulate and decode data transmission interval 120. The uplink control information transmission interval 130 between the data transmission interval 120 and the response signal transmission interval 140 may sufficiently provide time for the terminal or the base station to demodulate and decode the data transmission interval 120.

Further, the uplink control information transmission interval 130 is located between the data transmission interval 120 and the response signal transmission interval 140, and therefore the data transmission interval 120 and the response signal transmission interval 140 do not require a guard interval independent of whether the response signal transmission interval 140 is the uplink transmission or the downlink transmission. That is, when the terminal uses the response signal transmission interval 140, the response signal transmission interval 140 and the uplink control information transmission interval 130 both are the uplink transmission and therefore do not require the guard interval. Further, when the base station uses the response signal transmission interval 140, the base station does not consider a propagation delay time at a switching time for receiving the uplink signal and transmitting the downlink response signal and a hardware switching time of the base station itself may be shorter than a cyclic prefix (CP) time at a multi-carrier transmission signal like orthogonal frequency division multiplexing (OFDM).

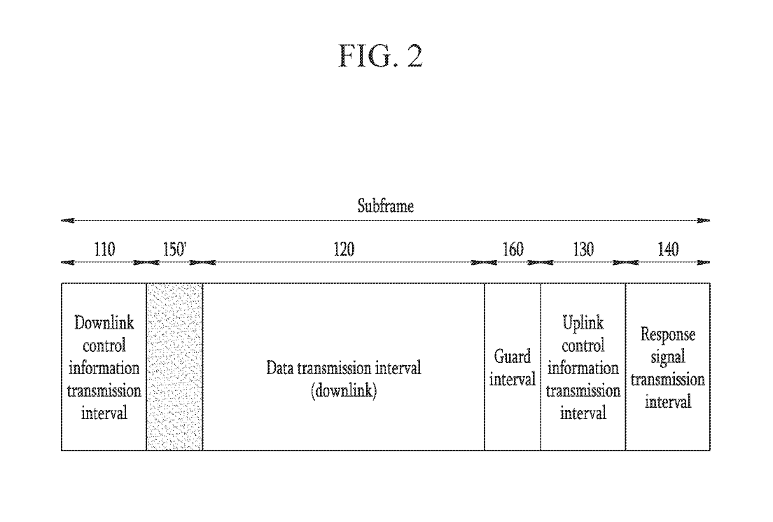

FIG. 2 is a diagram illustrating an example of the configuration of the subframe when a data transmission interval of the subframe according to the exemplary embodiment of the present invention is used as a downlink data transmission.

Referring to FIG. 2, when the data transmission interval 120 is used as the downlink data transmission, the guard interval 150 (FIG. 1) is not required between the downlink control information transmission interval 110 and the data transmission interval 120. Therefore, the base station uses a guard interval 150′ for additional downlink data transmission or downlink control information transmission

In the guard interval 150′, a downlink multi-carrier partial symbol having a time length smaller than or equal to the original guard interval 150 (FIG. 1) is transmitted. The downlink multi-carrier partial symbol is used to transmit additional downlink data or downlink control information. The multi-carrier partial symbol means a multi-carrier symbol made to occupy a time domain or a frequency domain smaller than the existing multi-carrier symbol. Therefore, in the duration of a normal multi-carrier symbol at least two multi-carrier partial symbols described in the exemplary embodiment of the present invention may be included.

As such, when the data transmission interval 120 is used as the downlink data transmission, in a subframe, only one guard interval 160 is used between the downlink data transmission interval 120 and the uplink control information transmission interval 130.

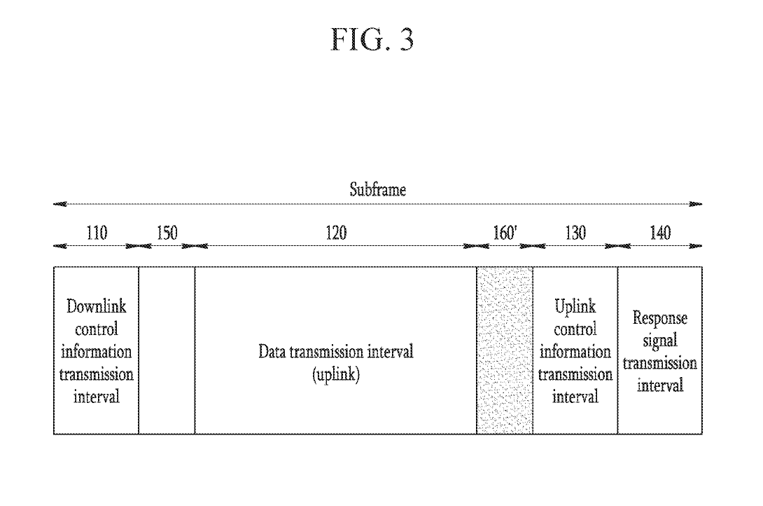

FIG. 3 is a diagram illustrating an example of the configuration of the subframe when a data transmission interval of the subframe according to the exemplary embodiment of the present invention is used as an uplink data transmission.

Referring to FIG. 3, when the data transmission interval 120 is used as the uplink data transmission, the guard interval 160 (FIG. 1) is not required between the downlink transmission interval 120 and the uplink control information transmission interval 130. Therefore, the terminal uses a guard interval 160′ for additional downlink data transmission or downlink control information transmission

In the guard interval 160′, an uplink multi-carrier partial symbol having a time length smaller than or equal to the original guard interval 160 (FIG. 1) is transmitted. The uplink multi-carrier partial symbol is used to transmit the additional uplink data or uplink control information.

As such, when the data transmission interval 120 is used as the uplink data transmission, in the subframe, only one guard interval 150 is used between the downlink control information transmission interval 110 and the data transmission interval 110.

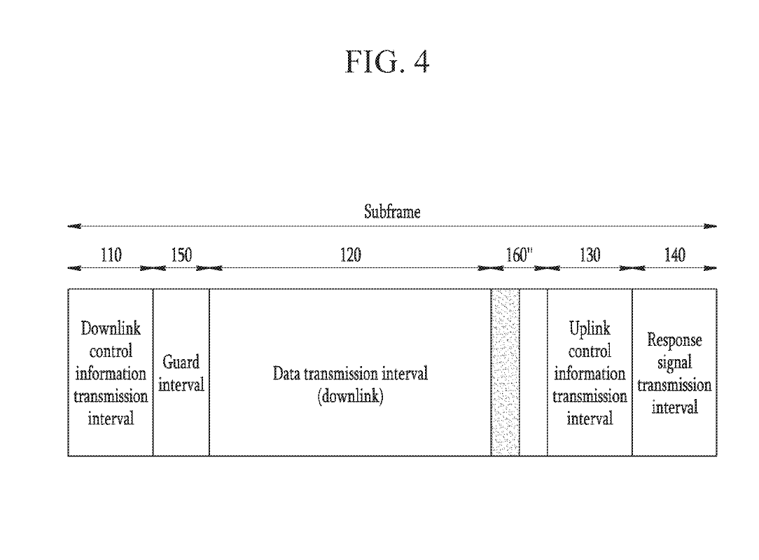

FIG. 4 is a diagram illustrating an example of a configuration of a subframe when a data transmission interval of a subframe according to another exemplary embodiment of the present invention is used as a downlink data transmission.

That is, when the data transmission interval 120 is used as the downlink data transmission, an example of the configuration of the subframe in the case of transmitting additional downlink partial symbol subsequent to the data transmission interval 120 depending on the distance between the base station and the terminal is described.

Referring to FIG. 4, a guard interval 160″ is set to include a round-trip delay time up to a cell boundary and a switching time for the terminal to receive a downlink signal and then transmit the uplink response signal. However, a size of the cell may be smaller than a size of a cell considered in the guard interval 160″ preset in the system and when the terminal approaches the base station, the round-trip delay time between the base station and the terminal is reduced, and therefore the additional transmission may be made in the preset guard interval 160″. The base station may receive an access channel that the terminal transmits to estimate the round-trip delay time to the terminal. The base station transmits an additional partial symbol for time corresponding to a difference between the round-trip delay time considered at the phase of configuring the subframe and the round-trip delay time to the corresponding terminal. That is, some interval continued to the guard interval 160″ in the guard interval 160″ may be used to transmit additional downlink data or downlink control information.

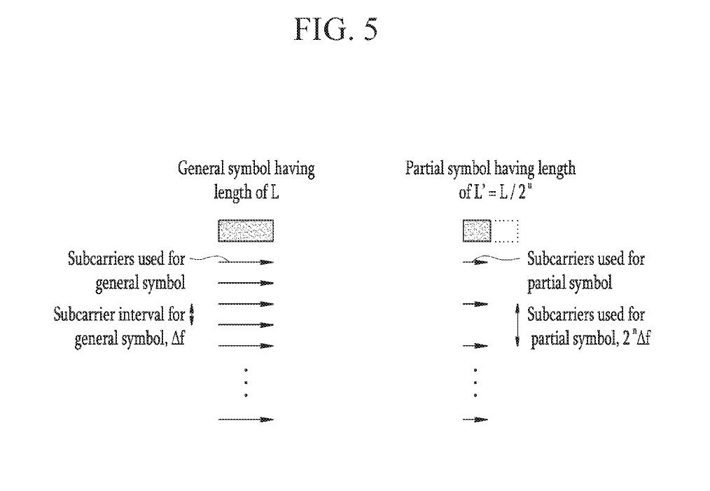

FIG. 5 is a diagram illustrating a configuration a multi-carrier partial symbol additionally transmitted in a guard interval according to an exemplary embodiment of the present invention.

Referring to FIG. 5, the multi-carrier partial symbol means a symbol having a time length smaller than the normal multi-carrier symbol transmitted in the interval other than the guard interval. When an effective or fast Fourier transform (FFT) interval length other than the CP in the normal multi-carrier symbol is set to be L, the effective or FFT interval length of the partial symbol has a relationship of L′[=L/2ⁿ (n=0, 1, 2, . . . )]. When a frequency spacing between subcarriers (subcarrier spacing) of the normal multi-carrier symbol is Δf, the multi-carrier partial symbol has a short transmission time, and therefore a subcarrier spacing of the multi-carrier partial symbol is increased to Δf′ (=2ⁿΔf) in a frequency aspect and the number of used subcarriers is also reduced to ½ⁿ times. For example, when the partial symbol is transmitted at a length of ½ compared to the length of the normal symbol, if the FFT size (or the number of subcarriers) used for the normal symbol is 1024, the FFT size (or the number of subcarriers) used for the partial symbol is 512. When n=0, the time length and the subcarrier spacing of the partial symbol that are transmitted in the guard interval are equal to the time length and the subcarrier spacing of the normal multi-carrier symbol.

The length of the multi-carrier partial symbol additionally used in FIGS. 2 and 3 is determined by a largest integer n satisfying the relationship of the following Equation 1.

L_{CP}p+L/2ⁿ≦L_{GI} (Equation 1)

In the above Equation 1, L_{CP} represents the time length of the CP and L_{GI} represents the time length of the guard interval.

In FIG. 4, the length of the additional multi-carrier partial symbol transmitted after the data transmission interval 120 is determined by the largest integer n satisfying the relationship of the following Equation 2.

L_{CP}+L/2ⁿ≦L−L_{SW}−L_{RTD} (Equation 2)

In the above Equation, L_{SW} represents the switching time for the terminal to transmit the uplink response signal after receiving the downlink signal and L_{RTD} represents the round-trip delay time estimated between the base station and the corresponding terminal. The estimated round-trip delay time may include a multipath delay spread time of a channel.

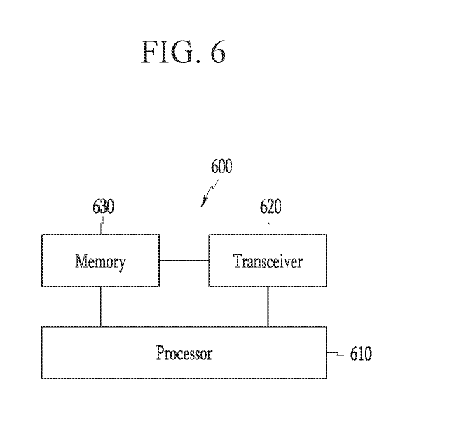

FIG. 6 is a diagram illustrating an apparatus for configuring a subframe according to an exemplary embodiment of the present invention.

Referring to FIG. 6, an apparatus 600 for configuring a subframe includes a processor 610, a transceiver 620, and a memory 630. The apparatus 600 for configuring a subframe may be implemented within the terminal or the base station.

The processor 610 configures the subframe described based on FIGS. 1 to 5 and transmits the subframe through the transceiver 620.

The transceiver 620 is connected to the processor 610 to transmit and receive a wireless signal.

The memory 630 stores instructions which are performed by the processor 610 or loads instructions from a storage (not illustrated) and temporarily stores the instructions and the processor 610 executes the instructions which are stored or loaded in the memory 630.

The processor 610 and the memory 630 are connected to each other through a bus (not illustrated) and an input/output interface (not illustrated) may also be connected to the bus. In this case, the transceiver 620 is connected to the input/output interface and peripheral devices such as an input device, a display, a speaker, and a storage may be connected to the input/output interface.

According to the exemplary embodiment of the present invention, it is possible to variably allocate the downlink transmission interval and the uplink transmission interval depending on the traffic request and increase the transmission efficiency by additionally transmitting the partial symbol at the response and guard interval within the subframe.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for configuring a subframe by a transmitting apparatus in a mobile communication system, comprising:
configuring the subframe consisting of a downlink control information transmission interval in which control information of a downlink is transmitted, a data transmission interval in which data are transmitted, an uplink control information transmission interval in which control information of an uplink is transmitted, and a response signal transmission interval in which a response signal to data reception is transmitted; and
transmitting the subframe.

2. The method of claim 1, wherein:
in the subframe, guard intervals are located between the downlink control information transmission interval and the data transmission interval and between the data transmission interval and the uplink control information transmission interval, respectively.

3. The method of claim 2, wherein:
when the data transmission interval is used as a downlink data transmission, the guard interval between the downlink control information transmission interval and the data transmission interval is used as a transmission interval of additional downlink data or downlink control information.

4. The method of claim 3, wherein:
in the guard interval between the downlink control information transmission interval and the data transmission interval, a multi-carrier partial symbol having a time length smaller than or equal to the guard interval is transmitted.

5. The method of claim 4, wherein:
a length of the multi-carrier partial symbol is determined by a largest integer n satisfying a relationship of L_{CP}+L/2ⁿ≦L_{GI} and a subcarrier spacing of the multi-carrier partial symbol has a relationship of 2ⁿΔf, and
the L_{CP} represents a length of CP, the n represents 0 or a positive integer, the L_{GI} represents a length of the guard interval, the L represents a length of an effective symbol interval other than the CP in a symbol transmitted in the data transmission interval, and Δf represents a subcarrier spacing of the symbol transmitted in the data transmission interval.

6. The method of claim 3, wherein:
some interval continued to the data transmission interval in the guard interval between the data transmission interval and the uplink control information transmission interval are used to transmit additional downlink data or downlink control information.

7. The method of claim 6, wherein:
in the some interval, a multi-carrier partial symbol is transmitted,
a length of the multi-carrier partial symbol is determined by a largest integer n satisfying a relationship of L_{CP}+L/2ⁿ≦L_{GI}−L_{SW}−L_{RTD} and a subcarrier spacing of the multi-carrier partial symbol has a relationship of 2ⁿΔf, and
the L_{CP} represents a length of CP, the n represents 0 or a positive integer, the L_{GI} represents a length of the guard interval, the L represents a length of an effective symbol interval other than the CP in a symbol transmitted in the data transmission interval, the L_{SW} represents a switching time between uplink transmissions after receiving a downlink, the L_{RTD} represents a round-trip delay time estimated between a base station and a terminal, and the Δf represents a subcarrier spacing of the symbol transmitted in the data transmission interval.

8. The method of claim 2, wherein:
when the data transmission interval is used as an uplink data transmission, a guard interval between the data transmission interval and the uplink control information transmission interval is used as a transmission interval of additional uplink data or uplink control information.

9. The method of claim 8, wherein:
in the guard interval between the data transmission interval and the uplink control information transmission interval, a multi-carrier partial symbol having a time length smaller than or equal to the guard interval is transmitted.

10. The method of claim 9, wherein:
a length of the multi-carrier partial symbol is determined by a largest integer n satisfying a relationship of L_{CP}+L/2ⁿ≦L_{GI} and a subcarrier spacing of the multi-carrier partial symbol has a relationship of 2ⁿΔf, and
the L_{CP} represents a length of CP, the n represents 0 or a positive integer, the L_{GI} represents a length of the guard interval, the L represents a length of an effective symbol interval other than the CP in a symbol transmitted in the data transmission interval, and Δf represents a subcarrier spacing of the symbol transmitted in the data transmission interval.

11. An apparatus for configuring a subframe in a mobile communication system, comprising:
a processor configuring the subframe consisting of a downlink control information transmission interval in which control information of a downlink is transmitted, a data transmission interval in which data are transmitted, an uplink control information transmission interval in which control information of an uplink is transmitted, and a response signal transmission interval in which a response signal to data reception is transmitted; and
a transceiver connected to the processor to transmit the subframe,
wherein in the subframe, guard intervals are located between the downlink control information transmission interval and the data transmission interval and between the data transmission interval and the uplink control information transmission interval, respectively.

12. The apparatus of claim 11, wherein:
when the data transmission interval is used as a downlink data transmission, the processor uses the guard interval between the downlink control information transmission interval and the data transmission interval as a transmission interval of additional downlink data or downlink control information.

13. The apparatus of claim 12, wherein:
the processor generates a multi-carrier partial symbol to be transmitted in the guard interval between the data transmission interval and the uplink control information transmission interval, and
the multi-carrier partial symbol has a time length smaller than or equal to the guard interval.

14. The apparatus of claim 13, wherein:
a length of the multi-carrier partial symbol is determined by a largest integer n satisfying a relationship of L_{CP}+L/2ⁿ≦L_{GI} and a subcarrier spacing of the multi-carrier partial symbol has a relationship of 2ⁿΔf, and
the L_{CP} represents a length of CP, the n represents 0 or a positive integer, the L_{GI} represents a length of the guard interval, the L represents a length of an effective symbol interval other than the CP in a symbol transmitted in the data transmission interval, and Δf represents a subcarrier spacing of the symbol transmitted in the data transmission interval.

15. The apparatus of claim 12, wherein:
the processor uses some interval continued to the data transmission interval in the guard interval between the data transmission interval and the uplink control information transmission interval to transmit additional downlink data or downlink control information.

16. The apparatus of claim 15, wherein:
the processor generates a multi-carrier partial symbol to be transmitted in the some interval.

17. The apparatus of claim 16, wherein:
a length of the multi-carrier partial symbol is determined by a largest integer n satisfying a relationship of L_{CP}+L/2ⁿ≦L_{GI}−L_{SW}−L_{RTD} and a subcarrier spacing of the multi-carrier partial symbol has a relationship of 2ⁿΔf, and
the L_{CP} represents a length of CP, the n represents 0 or a positive integer, the L_{GI} represents a length of the guard interval, the L represents a length of an effective symbol interval other than the CP in a symbol transmitted in the data transmission interval, the L_{SW} represents a switching time between uplink transmissions after receiving a downlink, the L_{RTD} represents a round-trip delay time estimated between a base station and a terminal, and the Δf represents a subcarrier spacing of the symbol transmitted in the data transmission interval.

18. The apparatus of claim 11, wherein:
when the data transmission interval is used as an uplink data transmission, the processor uses a guard interval between the data transmission interval and the uplink control information transmission interval as a transmission interval of additional uplink data or uplink control information.

19. The apparatus of claim 18, wherein:
the processor generates a multi-carrier partial symbol to be transmitted in the guard interval between the data transmission interval and the uplink control information transmission interval, and
the multi-carrier partial symbol has a time length smaller than or equal to the guard interval.

20. The apparatus of claim 19, wherein:
a length of the multi-carrier partial symbol is determined by a largest integer n satisfying a relationship of L_{CP}+L/2ⁿ≦L_{GI} and a subcarrier spacing of the multi-carrier partial symbol has a relationship of 2ⁿΔf, and
the L_{CP} represents a length of CP, the n represents 0 or a positive integer, the L_{GI} represents a length of the guard interval, the L represents a length of an effective symbol interval other than the CP in a symbol transmitted in the data transmission interval, and Δf represents a subcarrier spacing of the symbol transmitted in the data transmission interval.
